(19) United States
(12) Patent Application Publication
(10) Pub. No.: US 2003/0118113 A1
(43) Pub. Date: Jun. 26, 2003

(54) Fine-grain scalable video decoder with conditional replacement

(76) Inventors: Mary Lafuze Comer, Fairmount, IN (US); Izzat Hekmat Izzat, Carmel, IN (US)

Correspondence Address: JOSEPH S. TRIPOLI, THOMSON MULTIMEDIA LICENSING INC., 2 INDEPENDENCE WAY, SUITE #2, P. O. BOX 5312, PRINCETON, NJ, 08543-5312, US

(21) Appl. No.: 10/223,836

(22) Filed: Aug. 20, 2002

Related U.S. Application Data
(60) Provisional application No. 60/342,538, filed on Dec. 20, 2001.

(51) Int. Cl. H04N 7/12

(52) U.S. Cl. 375/240.25; 375/240.15

(57) ABSTRACT

A fine-grain scalable (FGS) encoder, decoder, and corresponding methods are disclosed which utilize conditional replacement for selecting between a base layer prediction and an enhancement layer prediction. Processes include: encoding data as a plurality of discrete cosine transform (“DCT”) coefficients for each of a base layer and an enhancement layer, a first conditional replacement (“CR”) portion in signal communication with the encoder for selecting between a base layer prediction and enhancement layer prediction for each DCT coefficient of the enhancement layer to increase coding efficiency, receiving encoded DCT data from encoder, decoding the encoded DCT data to produce reconstructed data responsive to the selected prediction, and a second CR portion in signal communication with the decoder for selecting between the base layer prediction and the enhancement layer prediction for each DCT coefficient of the enhancement layer to reduce prediction drift.

### CROSS-REFERENCE TO RELATED APPLICATION

This application claims the benefit of U.S. Provisional Patent Application Serial No. 60/342,538, entitled “Fine Granularity Scalable Video Coding Using Conditional Replacement” and filed Dec. 20, 2001, which is incorporated herein by reference in its entirety.

### FIELD OF THE INVENTION

The present invention is directed towards video CODECs, and in particular, towards fine-grain scalable video CODECs.

### BACKGROUND OF THE INVENTION

Video data is generally processed and transferred in the form of bit streams. A bit stream is fine-grain scalable if the bit stream can be decoded at a finely-spaced set of bitrates lower than the maximum coded bitrate of the bit stream. The Moving Pictures Experts Group (“MPEG”) 4 standard includes a fine-grain scalability mode.

There is an interest in video coding systems having the feature known as fine-grain scalability (“FGS”). With FGS, an encoded bit stream can be decoded at any one of a finely spaced set of bitrates between pre-determined minimum and maximum rates. Unfortunately, this type of scalability typically results in a coding efficiency that is significantly less than that of a non-scalable video coder-decoder (“CODEC”).

The MPEG-4 standard includes a mode for FGS video. In MPEG-4 FGS, the current frame is predicted using the previous frame decoded at the minimum bitrate for the stream. If a higher-bitrate version of the previous frame were used for prediction, this would lead to prediction drift any time the bit stream was decoded at a rate lower than the rate used for prediction in the encoder. The prediction drift is caused by the difference between the encoder's reference frame and the decoder's reference frame. Accordingly, it is desirable to improve the motion compensation efficiency of a CODEC over that of typical FGS schemes such as, for example, the FGS scheme adopted in the MPEG-4 standard, which suffers from poor coding efficiency.

### SUMMARY OF THE INVENTION

These and other drawbacks and disadvantages of the prior art are addressed by a system and method for a fine-grain scalable video CODEC with conditional replacement.

In accordance with the principles of the present invention, a decoder decodes encoded discrete cosine transform (“DCT”) coefficients for at least one of a base layer and an enhancement layer to provide reconstructed signal data, the decoder comprising a decoding conditional replacement unit for selecting between a base layer prediction and an enhancement layer prediction.

Similarly, a method for decoding signal data from encoded discrete cosine transform (“DCT”) coefficients to provide reconstructed signal data comprises choosing for conditional replacement between a base layer prediction and enhancement layer prediction for each DCT coefficient of the enhancement layer.

These and other aspects, features and advantages of the present invention will become apparent from the following description of exemplary embodiments, which is to be read in connection with the accompanying drawings.

### BRIEF DESCRIPTION OF THE DRAWINGS

The present invention teaches a fine-grain scalable video CODEC with conditional replacement in accordance with the following exemplary figures, in which:

FIG. 1 shows a block diagram of a fine-grain scalable (“FGS”) encoder;

FIG. 2 shows a block diagram for a Conditional Replacement function in accordance with the principles of the present invention;

FIG. 3 shows a block diagram of a Conditional Replacement FGS encoder in accordance with the principles of the present invention;

FIG. 4 shows a block diagram of a Conditional Replacement FGS decoder in accordance with the principles of the present invention;

FIG. 5 shows a comparative plot of Luma Peak Signal-to-Noise Ratio (“PSNR”) curves for an Akiyo sequence;

FIG. 6 shows a comparative plot of Luma PSNR curves for an Anchor sequence;

FIG. 7 shows a comparative plot of Luma PSNR curves for a Foreman sequence; and

FIG. 8 shows a comparative plot of Luma PSNR curves for a Hockey sequence.

### DETAILED DESCRIPTION OF PREFERRED EMBODIMENTS

The present invention improves the coding efficiency of fine-grain scalable (“FGS”) video. FGS coding may be applied to streaming content, such as, for example, streaming Internet video. An FGS scheme was recently adopted for the MPEG-4 standard, but this scheme suffers from poor coding efficiency. The present invention addresses this problem by providing improved motion compensation efficiency as compared to MPEG-4 FGS. The present invention utilizes a novel Conditional Replacement technique to improve the motion compensation in FGS, and thus results in a more computationally efficient architecture.

An exemplary motion compensation (“MC”) scheme for FGS video coding uses two MC loops, one for the base layer and one for the enhancement layer. A technique called Conditional Replacement (“CR”), which adaptively selects between the base layer and enhancement layer predictions for each enhancement layer discrete cosine transform (“DCT”) coefficient, is used to simultaneously improve coding efficiency and reduce prediction drift. An exemplary CR architecture is presented that uses reference frames stored in the spatial domain rather than in the DCT-domain. Whereas a straightforward implementation of a spatial-domain CR would utilize two extra DCTs to decode each 8×8 block, as compared to an FGS decoder not using CR, the presently disclosed architecture uses only one extra DCT to decode each block.

The following description merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the figures, (including functional blocks such as, for example, DCT, IDCT, VLC, Q, Q⁻¹, etc.) may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

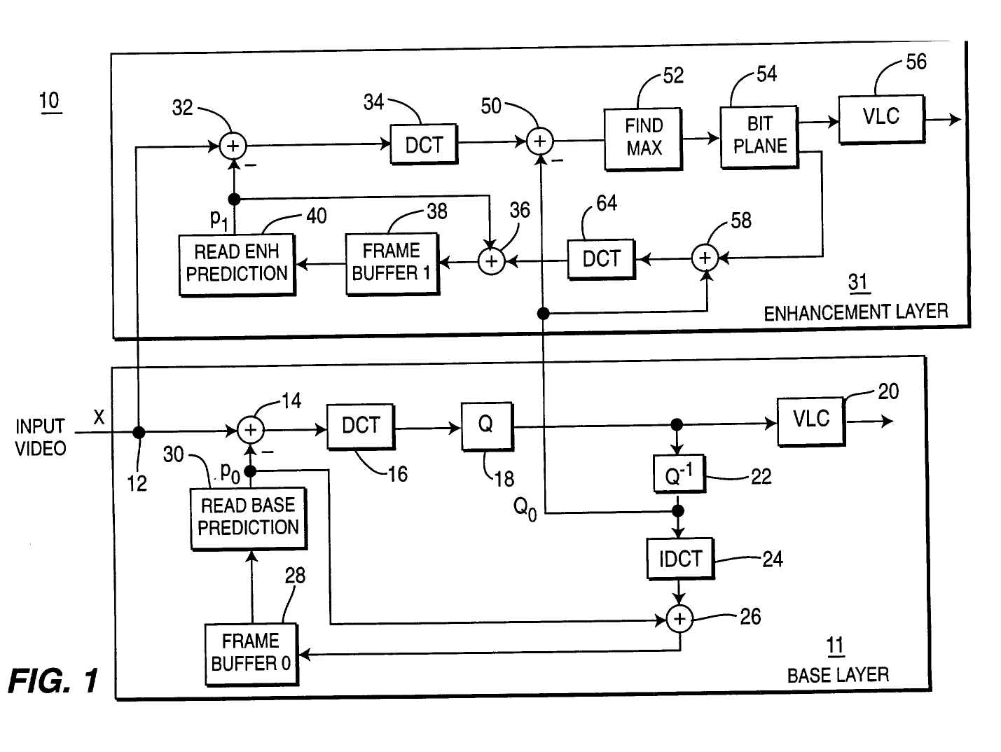

As shown in FIG. 1, an FGS encoder 10 can be conceptually broken up into a Base Layer MC loop 11 and an Enhancement Layer MC loop 31. The FGS encoder 10 includes a video input terminal 12 that is coupled in signal communication to a positive input of a summing block 14. The summing block 14 is coupled, in turn, to a function block 16 for implementing a DCT. The block 16 is coupled to a function block 18 for implementing the transform function Q. The function block 18 is coupled to a function block 20 for implementing Variable Length Coding (“VLC”). The block 18 is further coupled to a function block 22 for implementing the inverse transform function Q⁻¹. The block 22, in turn, is coupled to a function block 24 for implementing an Inverse Discrete Cosine Transform (“IDCT”). The block 24 is coupled to a positive input of a summing block 26, which is coupled to a block 28 representing a Frame Buffer 0. The block 28 is coupled to a function block 30 for reading a Base prediction p₀, which is passed to a negative input of the summing block 14 and also passed to a positive input of the summing block 26.

The video input terminal 12 is further coupled to a positive input terminal of a summing block 32, which, in turn, is coupled to a function block 34 for implementing a Discrete Cosine Transform. The block 34 is coupled, in turn, to a positive input of a summing block 50. The block 50 is coupled to a function block 52 for finding a maximum coefficient magnitude. The block 52 is coupled to a function block 54 for obtaining the bit planes, which are provided to a function block 56 for implementing Variable Length Coding. The block 54 is also coupled to a positive input of a summing block 58, which receives at another positive input the output of the function block 22. The summing block 58 is coupled, in turn, to a function block 64 for implementing an Inverse Discrete Cosine Transform. The block 64 is coupled to a positive input of a summing block 36, which, in turn, is coupled to a block 38 for implementing a Frame Buffer 1. The block 38 is coupled to a function block 40 for reading an Enhancement Layer prediction. The output of the function block 40 is coupled to a negative input of the summing block 32, and is also coupled to a positive input of the summing block 36.

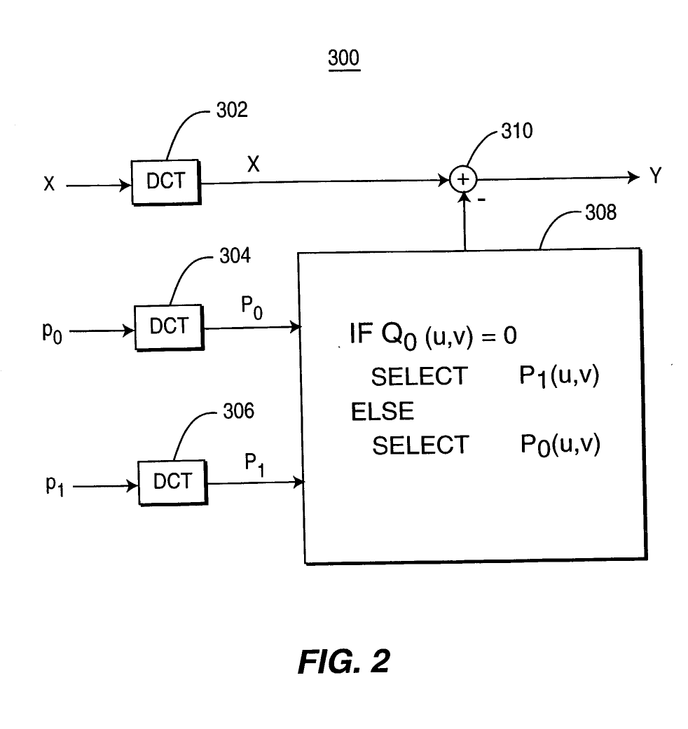

Turning to FIG. 2, an algorithm for Enhancement Layer prediction selection with Conditional Replacement is indicated generally by the reference numeral 300. The algorithm 300 includes a Discrete Cosine Transform 302 for transforming a signal x into a DCT signal X, a Discrete Cosine Transform 304 for transforming a Base Layer prediction signal p₀ into a DCT signal P₀, and a Discrete Cosine Transform 306 for transforming an Enhancement Layer prediction signal p₁ into a DCT signal P₁. The outputs of the Transforms 304 and 306 are received by a decision block 308, which selects P₁(u,v) if Q₀(u,v)=0, or else selects P0(u,v) if Q₀(u,v) is not equal to zero. The output of the decision block 308 is received at a negative input of a summing block 310, which receives at a positive input the output X of the Transform 302. The output of the summing block 310 is the signal Y, where Y=X−P₁ if Q₀=0, or Y=X−P₀ if Q₀ is non-zero.

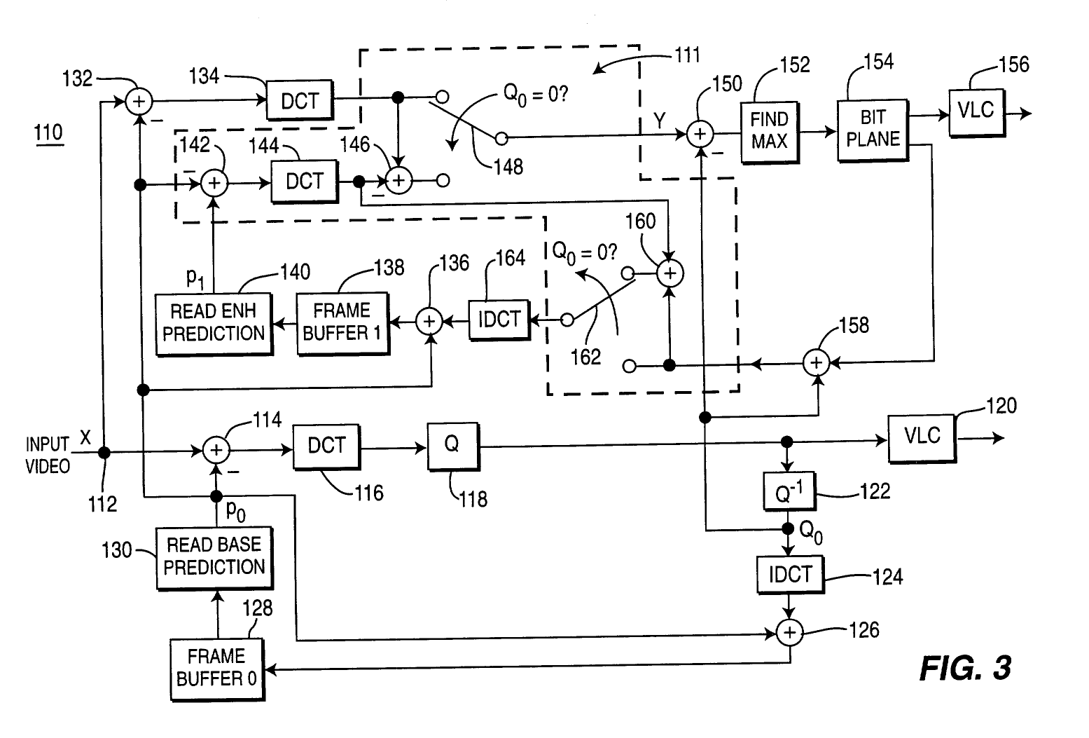

As shown in FIG. 3, a Conditional Replacement FGS encoder is indicated generally by the reference numeral 110, where the area 111 implements the Conditional Replacement 300 of FIG. 2. The Conditional Replacement FGS encoder 110 can be conceptually broken up into a Base Layer motion compensation loop and an Enhancement Layer motion compensation loop. The FGS encoder 110 includes a video input terminal 112 that is coupled in signal communication to a positive input of a summing block 114. The summing block 114 is coupled, in turn, to a function block 116 for implementing a Discrete Cosine Transform (“DCT”). The block 116 is coupled to a function block 118 for implementing the transform function Q. The function block 118 is coupled to a function block 120 for implementing Variable Length Coding (“VLC”). The block 118 is further coupled to a function block 122 for implementing the inverse transform function Q⁻¹. The block 122, in turn, is coupled to a function block 124 for implementing an Inverse Discrete Cosine Transform (“IDCT”). The block 124 is coupled to a positive input of a summing block 126, which is coupled to a block 128 representing a Frame Buffer 0. The block 128 is coupled to a function block 130 for reading a Base prediction p₀, which is passed to a negative input of the summing block 114 and also passed to a positive input of the summing block 126.

The video input terminal 112 is further coupled to a positive input terminal of a summing block 132, which, in turn, is coupled to a function block 134 for implementing a Discrete Cosine Transform. A summing block 136 receives the output p₀ of the function block 130, and is coupled to a block 138 for implementing a Frame Buffer 1. The block 138 is coupled to a function block 140 for reading an Enhancement Layer prediction. The output of the function block 140 is coupled to a positive input of a summing block 142, which also receives the signal p₀ from the function block 130 at a negative input. The output of the summing block 142 is coupled to a Discrete Cosine Transform 144, which, in turn, is coupled to a negative input of a summing block 146. The block 146 receives at a positive input a signal from the DCT 134. A switch 148 selects between the outputs of blocks 134 and 146, which are equal to X−P₀ and X−P₀−(P₁−P₀)=X−P₁, respectively. If Q₀=0, Y=X−P₁ is selected from block 146, or, if Q₀ is non-zero, Y=X−P₀ is selected from block 134.

The output Y of the switch 148 is coupled to a positive input of a summing block 150. The block 150 is coupled to a function block 152 for finding a maximum coefficient magnitude. The block 152 is coupled to a function block 154 for obtaining the bit planes, which are provided to a function block 156 for implementing Variable Length Coding. The block 154 is also coupled to a positive input of a summing block 158, which receives at another positive input the output of the function block 122. The summing block 158 is coupled, in turn, to a positive input of a summing block 160. The summing block 160 also receives at another positive input a signal from the DCT 144. A switch 162 selects between the outputs of blocks 158 and 160. If Q₀=0, a signal is selected from block 160, or, if Q₀ is non-zero, a signal is selected from block 158. The output of the switch 162 is coupled to a function block 164 for implementing an Inverse Discrete Cosine Transform. The block 164 is coupled to a positive input of the summing block 136.

It shall be understood by those of ordinary skill in the pertinent art that any process described herein with respect to an encoder may be generally reversed for a corresponding decoder.

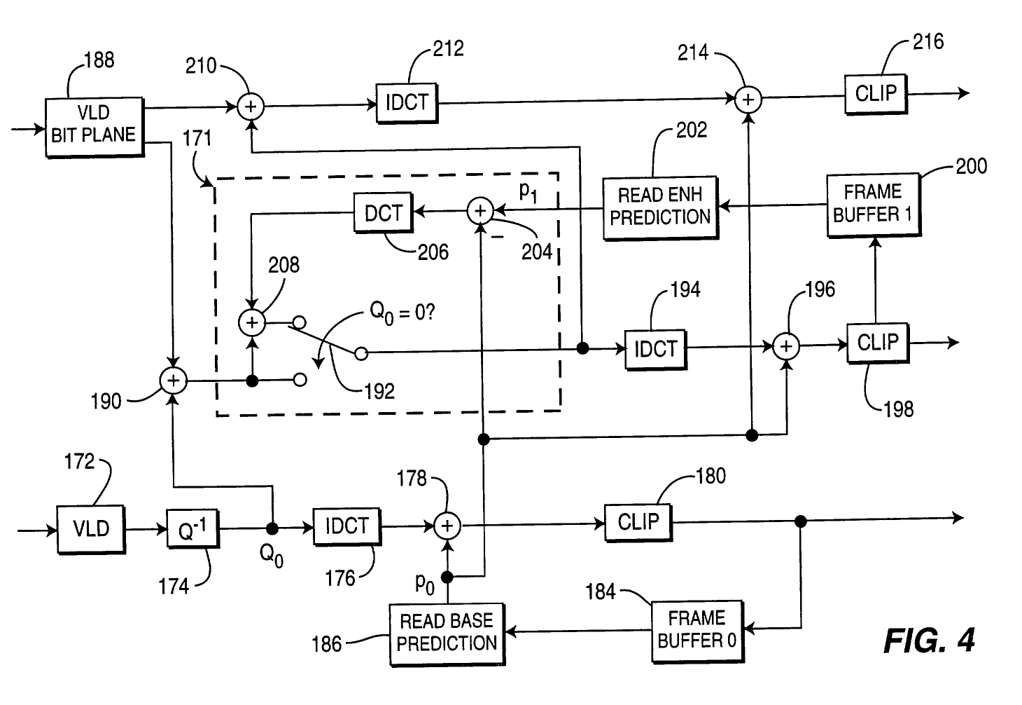

Turning to FIG. 4, a Conditional Replacement FGS decoder is indicated generally by the reference numeral 170. The area 171 implements the conditional replacement. The decoder 170 includes a function block 172 to receive a signal produced by the function block 120 of FIG. 3. The block 172 implements Variable Length Decoding (“VLD”), and is coupled, in turn, to a function block 174 for implementing the inverse transform function Q⁻¹. The block 174 is coupled to a function block 176 for implementing an Inverse Discrete Cosine Transform (“IDCT”) as known in the art. The block 176 is coupled to a positive input of a summing block 178, which is coupled to a function block 180 for clipping the signal. The block 180 is coupled, in turn, to a block 184 for implementing a Frame Buffer 0. The block 184 is coupled to a function block 186 for reading a base layer prediction p₀, and passing p₀ to another positive input of the summing block 178.

The decoder 170 further includes a function block 188 to receive a signal produced by the function block 156 of FIG. 3. The block 188 implements variable-length decoding in the bit plane, and leads to a positive input of a summing block 190. The block 190 is coupled to a first input of a switch 192, which selects this first input if Q₀=0. The output of the switch 192 is coupled to a function block 194 for implementing an Inverse Discrete Cosine Transform, which is coupled to a positive input of a summing block 196. Another positive input of the summing block 196 receives the prediction p₀ from the block 186. The output of the summer 196 is coupled to a function block 198 for clipping the enhancement layer output. The block 198 is coupled to a function block 200 for implementing a Frame Buffer 1, which is coupled, in turn, to a function block 202 for reading the enhancement layer prediction p₁. The prediction p₁ is passed to a positive input of a summing block 204, which is coupled to a function block 206 for implementing a discrete cosine transform. A negative input of the summing block 204 receives the prediction p₀ from the block 186. The block 206 is coupled to a positive input of a summing block 208, which receives at another positive input an output of the summing block 190. The output of the summing block 208 is coupled to a second input of the switch 192, which selects this second input if Q₀ is non-zero.

The function block 188 is further coupled to a positive input of a summing block 210, which has its output coupled, in turn, to a function block 212 for implementing an Inverse Discrete Cosine Transform. Another positive input of the summing block 210 is coupled to the output of the switch 192. The block 212 is coupled to a positive input of a summing block 214, which has another positive input coupled to the block 186 for receiving the prediction p₀. The output of the block 214 is coupled to a function block 216 for clipping the output.

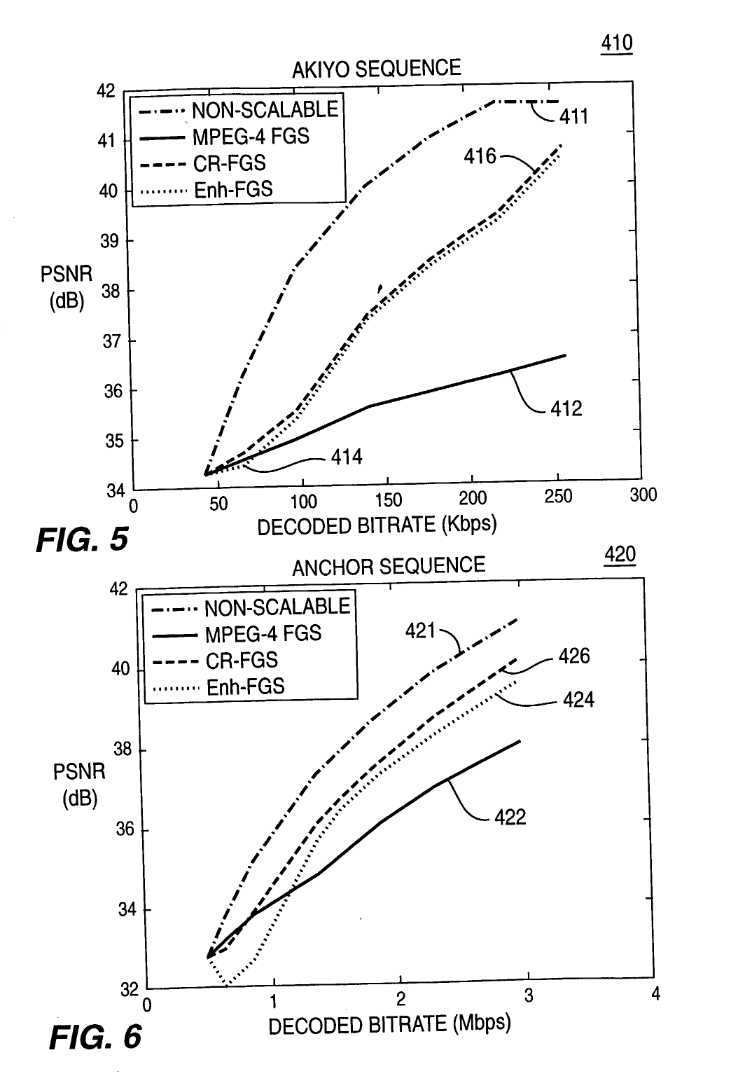

As shown in FIG. 5, a plot of Luma or brightness peak signal-to-noise ratio (“PSNR”) curves for an Akiyo sequence, having a base layer bitrate of 44000 bps, is indicated generally by the reference numeral 410. The plot 410 includes a non-scalable sequence 411, an MPEG-4 FGS sequence 412, an enhancement layer FGS sequence 414, and a conditional replacement FGS sequence 416 according to a preferred embodiment of the present invention. The Luma component represents the brightness information and is used to evaluate each coding scheme without the color information, which is referred to as Chroma.

Turning to FIG. 6, a plot of Luma PSNR curves for an Anchor sequence, having a base layer bitrate of 500000 bps, is indicated generally by the reference numeral 420. The plot 420 includes a non-scalable sequence 421, an MPEG-4 FGS sequence 422, an enhancement layer FGS sequence 424, and a conditional replacement FGS sequence 426 according to a preferred embodiment of the present invention.

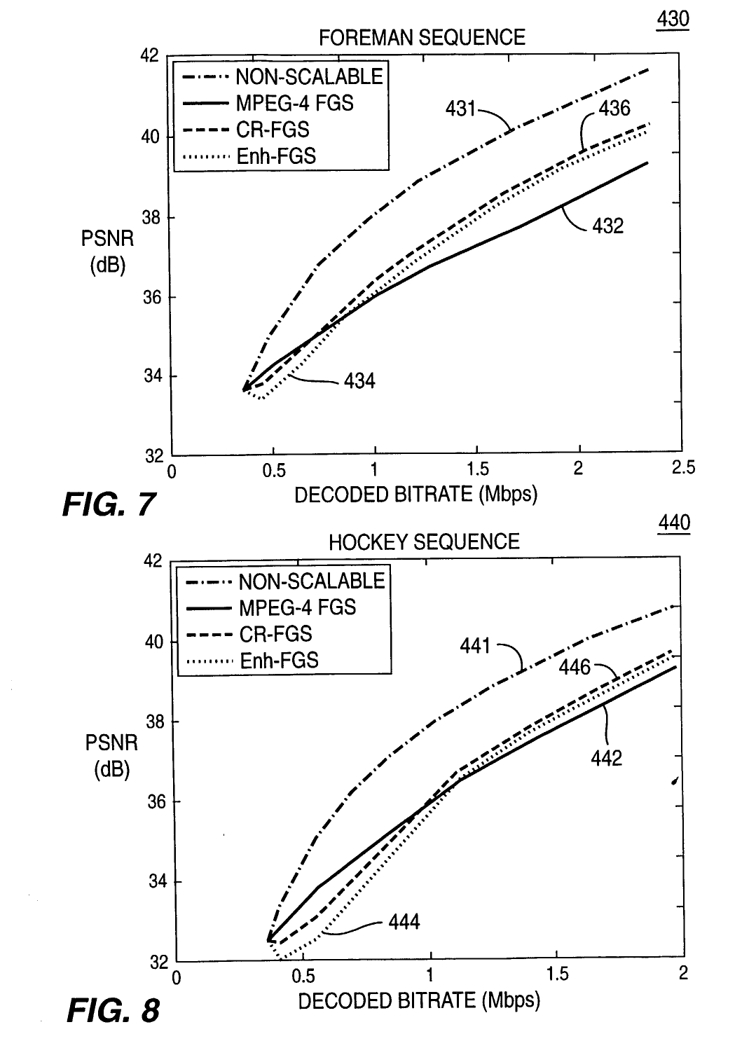

Turning now to FIG. 7, a plot of Luma PSNR curves for a Foreman sequence, having a base layer bitrate of 375000 bps, is indicated generally by the reference numeral 430. The plot 430 includes a non-scalable sequence 431, an MPEG-4 FGS sequence 432, an enhancement layer FGS sequence 434, and a conditional replacement FGS sequence 436 according to a preferred embodiment of the present invention.

As shown in FIG. 8, a comparative plot of Luma PSNR curves for a Hockey sequence, having a base layer bitrate of 375000 bps, is indicated generally by the reference numeral 440. The plot 440 includes a non-scalable sequence 441, an MPEG-4 FGS sequence 442, an enhancement layer FGS sequence 444, and a conditional replacement FGS sequence 446 according to a preferred embodiment of the present invention.

The recently adopted MPEG-4 standard for a fine-granularity scalability (“FGS”) mode is expected to be useful for streaming Internet video. This MPEG-4 FGS suffers from a severe loss in coding efficiency as compared to a non-scalable video CODEC. The new FGS scheme of the instant invention utilizes two motion compensation (“MC”) loops, advantageously resulting in improved coding efficiency.

TABLE 1
MAXIMUM PREDICTION DRIFT (DB)

| sequence | Enh-FGS | CR-FGS |
|---|---|---|
| Akiyo | 0.13 | 0 |
| Anchor | 1.16 | 0.19 |
| Foreman | 0.6 | 0.25 |
| Hockey | 1.24 | 0.68 |

Thus, FIGS. 5 through 8 show PSNR curves comparing the four schemes. Table 1 shows the maximum prediction drift, over all decoded bitrates, for CR-FGS and Enh-FGS. It is assumed that prediction drift is occurring if the PSNR is less than the PSNR for MPEG-4 FGS, since a primary difference between these two schemes and MPEG-4 FGS is the use of the enhancement layer for motion compensation. The drift is measured as the reduction in PSNR compared to MPEG-4 FGS.

TABLE 2
MAXIMUM CODING EFFICIENCY GAIN (DB)

| | CR-FGS vs. | CR-FGS vs. | Non-scalable vs. |
|---|---|---|---|
| sequence | Enh-FGS | MPEG-4 FGS | CR-FGS |
| Akiyo | 0.17 | 4.29 | 2.93 |
| Anchor | 0.58 | 2.13 | 1.26 |
| Foreman | 0.24 | 1.1 | 1.70 |
| Hockey | 0.24 | 0.44 | 1.86 |

Table 2 shows the maximum improvement in coding efficiency for CR-FGS versus Enh-FGS, and for CR-FGS versus MPEG-4 FGS, considering only bitrates beyond the prediction drift region. Also shown in Table 2 is the coding efficiency gain of non-scalable MPEG-4 coding over CR-FGS.

It can be seen from FIGS. 5 through 8 and Tables 1 and 2 that, for all sequences and all bitrates tested, CR-FGS outperforms Enh-FGS. CR-FGS provides both better coding efficiency and less prediction drift than Enh-FGS. The decrease in prediction drift with CR-FGS is significant, but analysis of the subjective visual impact of the remaining prediction drift associated with CR-FGS may be used to meet design criteria. If further reduction in prediction drift is desired, other methods as known in the art may be combined with CR-FGS. However, unlike CR-FGS, these methods may reduce drift at the expense of coding efficiency.

Compared to MPEG-4 FGS, there is a dramatic improvement in coding efficiency with CR-FGS, especially for the lower-motion sequences Akiyo and Anchor. However, there is still about a 1-3 dB loss in coding efficiency compared to non-scalable coding. It shall be understood that further improvements in efficiency may be gained by using a more efficient enhancement layer bit-plane encoding method. The methods presented herein may be used in combination with improved-efficiency bit-plane encoding methods.

Although prior attempts at FGS schemes may have been directed towards balancing the trade-off between coding efficiency and prediction drift in the enhancement layer, the assumption has been that an enhancement layer reference frame would always provide better coding efficiency than a base layer reference, thus teaching away from using the base layer reference. The present invention makes use of the base layer reference frame for prediction of some of the enhancement layer DCT coefficients to provide better coding efficiency.

An adaptive scheme that chooses between the base layer and enhancement layer predictions for each low frequency enhancement layer DCT coefficient in a block was only for frequency scalability, and was only usable for low frequency coefficients. The present invention for CR in FGS video coding is applicable to all of the DCT coefficients.

Using CR for FGS has at least two advantages over exclusively using an enhancement layer reference frame to predict the current enhancement layer. First, CR provides improved coding efficiency. Second, CR reduces the amount of prediction drift since only the DCT coefficients that are predicted from the previous enhancement layer will contribute to drift, as opposed to all of the DCT coefficients contributing. Those coefficients predicted from the previous base layer will not be subject to drift, because there is no drift in the base layer. The use of the enhancement layer for prediction, which is the cause of prediction drift, is restricted to only those coefficients for which the enhancement layer is expected to provide improved coding efficiency. This simultaneous improvement in coding efficiency and reduction in prediction drift make CR very attractive for FGS. The prior art teaches that the enhancement layer prediction always provides better coding efficiency than the base layer prediction. The present invention rebuts that teaching, and shows that prior schemes necessarily reduced coding efficiency and increased prediction drift for some of the coefficients for which enhancement layer prediction was used.

The prior art architecture for a CR encoder for frequency scalability assumed that the reference frames would be stored in memory in the DCT domain, in which case CR would have been very simple computationally. Unfortunately, in MPEG-4 FGS, the frames are stored in memory in the spatial domain. One embodiment of the present invention, one with a straightforward implementation of CR, requires two extra DCTs, because both the base layer and enhancement layer predictions are transformed into the DCT domain before the CR can be performed. In a preferred embodiment of the present invention shown in FIG. 3, an architecture is presented that requires only one extra DCT for CR.

The version of FGS that has been adopted in MPEG-4 uses only the base layer reference frame to predict the current frame being coded, with only one MC loop. For each coded frame, there is one prediction error frame, which is coded in a fine-granular scalable manner. No bits from the enhancement layer are ever used for prediction, making the motion compensation very inefficient. Prior proposals to make the motion compensation more efficient by using part of the enhancement layer for prediction have had serious drawbacks.

One such prior FGS scheme uses one MC loop, which results in one prediction error frame. Since an enhancement layer reference frame is used to create the prediction error frame, there will generally be drift when only the base layer is decoded, as well as when the enhancement layer is decoded at a bitrate lower than the enhancement layer reference frame bitrate. However, using two MC loops, one for the base layer and one for the enhancement layer, ensures that there will never be any prediction drift in the base layer.

Thus, prediction drift in the enhancement layer can be reduced by sometimes using the base layer reference frame for motion compensation in the enhancement layer. For example, the base layer may be used periodically for enhancement layer prediction in such a way that the longest possible drifting path, measured in number of frames, is equal to the number of layers. An enhancement layer reference frame could be used for prediction of the enhancement layer, but the base layer reference frame could, at least sometimes, be used for reconstruction of an enhancement layer frame to be used as a reference for the next picture. An FGS scheme that adaptively chooses between the base layer and enhancement layer for prediction/reconstruction at the macroblock level, instead of at the frame level, is an improvement. However, conditional replacement, which adaptively chooses between base layer and enhancement layer prediction at the DCT coefficient level, is preferred.

The following notation is defined in order to describe the operation of embodiments of the present invention. The input block to be coded is referred to as x. The prediction blocks from the base layer and enhancement layer reference frames are denoted p₀ and p₁, respectively. The discrete cosine transform (“DCT”) of each of these blocks are denoted using upper case, i.e., X, P₀, and P₁, respectively. The inverse-quantized base layer DCT coefficients of the current block are referred to as Q₀. The coordinates (u,v) are used to refer to the individual elements in a DCT-domain block.

It is reasonable to assume, as a starting point, that P₁(u,v) is a better prediction for X(u,v) than P₀(u,v). However, the value that is to be predicted in the enhancement layer is effectively not X(u, v), but rather X(u,v)−Q₀(u,v), as can be seen by examining FIG. 1. The present invention makes use of the realization that for FGS, the base layer prediction is in some cases a better prediction for the difference between the original DCT coefficient and the inverse-quantized base layer coefficient. Thus, the present invention uses a CR scheme to select adaptively between P₀(u,v) and P₁(u,v) as the prediction for X(u,v)−Q₀(u,v). The decision of which prediction to use is based on the value of Q₀(u,v). More specifically, if Q₀(u,v)=0 the enhancement layer prediction P₁(u,v) should be used, and if Q₀(u,v) is non-zero the base layer prediction P₀(u,v) should be used. Since Q₀ is known at the decoder, there is no additional overhead needed to perform the CR. FIG. 2 is an illustration of the enhancement layer prediction selection process with CR.

For FGS with Conditional Replacement (“CR”), the decision of which prediction to use must be made in the DCT domain. A decoder using the straightforward implementation shown in FIG. 2 uses two more DCTs than does a two-loop FGS decoder not using CR. Instead of computing X, P₀, and P₁ separately using three DCTs, the CR-FGS CODEC preferred in the present invention computes X−P₀ and P₁−P₀. Then, if Q₀(u,v) is non-zero, the prediction error Y(u,v) between the original enhancement layer coefficient and the prediction is simply:

Y(u,v)=X(u,v)−P₀(u,v)

If Q₀(u,v)=0, the value of Y(u,v) is computed as:

Y(u,v)=X(u,v)−P₀(u,v)−(P₁(u,v)−P₀(u,v))=X(u,v)−P₁(u,v)

This is equivalent to the procedure shown in FIG. 2, but with only two DCTs instead of three. The CR-FGS encoder using this preferred architecture for CR is shown in FIG. 3. The area 111 indicates the additional computation required for CR, as compared to an FGS encoder, which always uses the enhancement layer for prediction, for example. FIG. 4 shows the CR-FGS decoder. Here, the shaded 171 shows the additional computation for CR, as compared to an FGS decoder, which always uses the enhancement layer for prediction, for example. It shall be understood by those of ordinary skill in the pertinent art that many prior schemes proposed to reduce the effects of prediction drift may each be combined with the CR of the present invention, with relatively simple modifications to the preferred systems shown in FIGS. 3 and 4.

The experimental results demonstrating the performance of the CR-FGS algorithm are presented in FIGS. 5, 6, 7 and 8 for four 30 frames per second (“fps”) progressive sequences: the 176×144 MPEG test sequence Akiyo, a 352×240 sequence showing a news anchor scene with a camera zoom motion (“Anchor”), the 352×288 MPEG test sequence Foreman, and the 352×240 MPEG test sequence hockey. For comparison, PSNR results are also presented for non-scalable MPEG4, MPEG-4 FGS and “Enh FGS”, which uses two MC loops and always selects the enhancement layer prediction for enhancement layer MC, as shown in FIG. 1. The sequences were encoded with 14 Predictive (“P”) pictures between Intra (“I”) pictures and with no Bi-directional (“B”) pictures, where P, I and B are MPEG terms as known in the art. For each frame in CR-FGS and Enh FGS, 3 bit planes from the enhancement layer were used to reconstruct the enhancement layer reference frame for the next picture.

The experimental results illustrated in FIGS. 5, 6 and 7 show that for all sequences and all bitrates tested, CR-FGS outperformed Enh FGS. CR-FGS provides both better coding efficiency and less prediction drift than does Enh FGS. If it is assumed that prediction drift is occurring when the PSNR is less than the MPEG-4 FGS PSNR is, and the drift is measured as the reduction in PSNR compared to MPEG-4 FGS, then the maximum drift for Enh FGS is 0.47 dB for Akiyo, 1.39 dB for Anchor, and 0.98 dB for Foreman. The maximum prediction drift for CR-FGS is only 0.24 dB for Akiyo, 0.34 dB for anchor, and 0.59 dB for foreman. Looking at coding efficiency gain, not including the prediction drift region, CR-FGS provides up to 0.23 dB improvement for Akiyo, 0.71 dB for anchor, and 0.26 dB for foreman, as compared to Enh FGS. Comparing coding efficiency between CR-FGS and MPEG-4 FGS, again considering bitrates beyond the prediction drift region, CR-FGS provides up to 1.42 dB improvement for Akiyo, 1.86 dB for anchor, and 0.51 dB for foreman.

Considering the simultaneous reduction in prediction drift and improvement in coding efficiency compared to Enh FGS, CR-FGS provides an attractive approach to improving FGS coding efficiency. If further reduction in prediction drift is desired, other methods as known in the art may be combined with CR-FGS. However, these methods may reduce drift at the expense of coding efficiency.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

What is claimed is:

1. A decoder for decoding encoded discrete cosine transform (“DCT”) coefficients for at least one of a base layer and an enhancement layer to provide reconstructed signal data, the decoder comprising a decoding conditional replacement unit for selecting between a base layer prediction and an enhancement layer prediction.

2. A decoder as defined in claim 1 wherein the signal data comprises streaming video signal data that is fine-grain scalable between a minimum bitrate and a maximum bitrate.

3. A decoder as defined in claim 1 wherein said decoding conditional replacement unit comprises a single inverse discrete cosine transformer.

4. A decoder as defined in claim 1 wherein said decoding conditional replacement unit comprises a decoding selector responsive to inverse-quantized base layer DCT coefficients.

5. A decoder as defined in claim 1 wherein said decoding conditional replacement unit comprises:
a single inverse discrete cosine transformer; and
a decoding selector in signal communication with said single inverse discrete cosine transformer, the decoding selector being responsive to inverse-quantized base layer DCT coefficients.

6. A decoder comprising:
decoder means for decoding encoded discrete cosine transform (“DCT”) coefficients for at least one of a base layer and an enhancement layer to provide reconstructed signal data; and
conditional replacement means coupled to the decoding means for selecting between a base layer prediction and an enhancement layer prediction for each DCT coefficient of the enhancement layer.

7. A decoder as defined in claim 6, further comprising:
base receiver means for receiving base layer coefficients for the DCT domain;
base inverse-quantization means for inverse-quantizing the base layer coefficients into the spatial domain;
base prediction means for predicting base layer coefficients for the spatial domain;
enhancement receiver means for receiving enhancement layer coefficients for the DCT domain;
selection means for selecting between a base layer coefficient prediction and an enhancement layer coefficient prediction for each enhancement layer DCT coefficient in accordance with the inverse-quantized base layer DCT coefficients;
conditional replacement means for conditionally replacing each enhancement layer DCT coefficient with a prediction responsive to said selection;
enhancement inverse-quantization means for inverse-quantizing the enhancement layer coefficients into the spatial domain; and
enhancement prediction means for predicting enhancement layer coefficients for the spatial domain responsive to said conditional replacement.

8. A method for decoding signal data from encoded discrete cosine transform (“DCT”) coefficients to provide reconstructed signal data, the method comprising choosing for conditional replacement between a base layer prediction and enhancement layer prediction for each DCT coefficient of the enhancement layer.

9. A method as defined in claim 8, further comprising:
receiving base layer coefficients for the DCT domain;
inverse-quantizing the base layer coefficients into the spatial domain;
predicting base layer coefficients for the spatial domain;
receiving enhancement layer coefficients for the DCT domain;
selecting between a base layer coefficient prediction and an enhancement layer coefficient prediction for each enhancement layer DCT coefficient in accordance with the inverse-quantized base layer DCT coefficients;
conditionally replacing each enhancement layer DCT coefficient with a prediction responsive to said selection;
inverse-quantizing the enhancement layer coefficients into the spatial domain; and
predicting enhancement layer coefficients for the spatial domain responsive to said conditional replacement.

10. A method as defined in claim 9 wherein conditionally replacing with a prediction is responsive to inverse-quantized base layer DCT coefficients.

11. A method as defined in claim 8 wherein the signal data is streaming video signal data.

12. A method as defined in claim 8 wherein the signal data is fine-grain scalable between a minimum bitrate and a maximum bitrate.
